(19) United States
(12) Patent Application Publication
(10) Pub. No.: US 2005/0156713 A1
(43) Pub. Date: Jul. 21, 2005

(54) Serveralert

(76) Inventors: James Scott McClure, Ft. Lauderdale, FL (US); Jean Marie Frohring, Davie, FL (US)

Correspondence Address: James Scott McClure, 4620 N.E. 5th Ave., Ft. Lauderdale, FL, 33334, US

(21) Appl. No.: 10/760,154

(22) Filed: Jan. 20, 2004

(51) Int. Cl. G08B 1/00

(52) U.S. Cl. 340/286.09

(57) ABSTRACT

The project is designed to direct the attention of a resturant server towards their customers. The unit unfolds to a max. of 60 degrees to enable it to sit in a stable position on top of a flat surface. The unit would be powered by 3 volt flat batteries. The unit is activated by the touch of a button. When activated, the unit will illuminate by a series flashing bulbs. The unit is turned off with the same on/off button.

### BACKGROUND OF THE INVENTION

Currently there are devices that alert resturant customers that a table is available from a hostess station and devices that alert servers to the kitchen when food is available. How many times have we all been waiting at a table for extended periods of time with no sight of our server or aknowledgement from other servers? By the time a server does arrive your patients have worn thin and your dining experience is no longer pleasureable.

The “ServerAlert” is a product much needed in the resturant/server industry.

The “ServerAlert” is designed to immediately get the attention of your server. The unit would be small enough to avoid obstructions on the table approximately 6″ in height and 3″ in width. The base would be a colored transparent plastic to illuminate the flashing circuit lights giving off a colored glow for high visablilty to resturant employees in any lighting conditon. When a customer is in need of service they simply expand the unit beyond 35 degrees for the unit to illuminate. When the server arrives he/she folds the unit back to 35 degrees or less to deactivate the flashing light. The design would be fully collapsable for convenient stacking and storing.

### SUMMARY OF INVENTION

The invention relates to resturant server/customer relations.

The purpose of this invention is to improve resturant server efficiency by directing attention to a server's table when customers are in need of help. The server or hostess puts the unit on the table when a party is seated and explains how to activate the unit when in need of service. The unit would sit on the table top in a postion of 35 degrees or less about 6″ tall. When a customer is in need of a server's attention they would simply expand the unit slightly past 35 degrees to illuminate the flashing bulbs.

### DESCRIPTION OF DRAWINGS

In order to fully understand the present invention, reference is made to the accompanying drawings. Understanding that these drawings are not to be considered limitations in the scope of the invention, but as the presently understood best mode of the invention are described with additional use of the accompanying drawings.

FIG. 1 of 3 is a perspective schematic view of the invention to show the overall shape, configuration and aeshetics of the unit.

FIG. 2 of 3 is a front view elevation of the invention to show the overall dimensions of the unit.

FIG. 3 of 3 is a side view elevation of the invention to show the thickness and expansion capablility of the unit.

The foregoing is considered as illustrative only of the principles of the invention. Further, since numerous modifications and changes will readily occur to those skilled in the art of its fabrication, it is desired to not limit the invention to the exact construction and operation shown and described, and accordingly, all suitable modifications and aquivalents may be resorted to, falling within the scope of the invention.

### DESCRIPTION OF EMBODIMENT

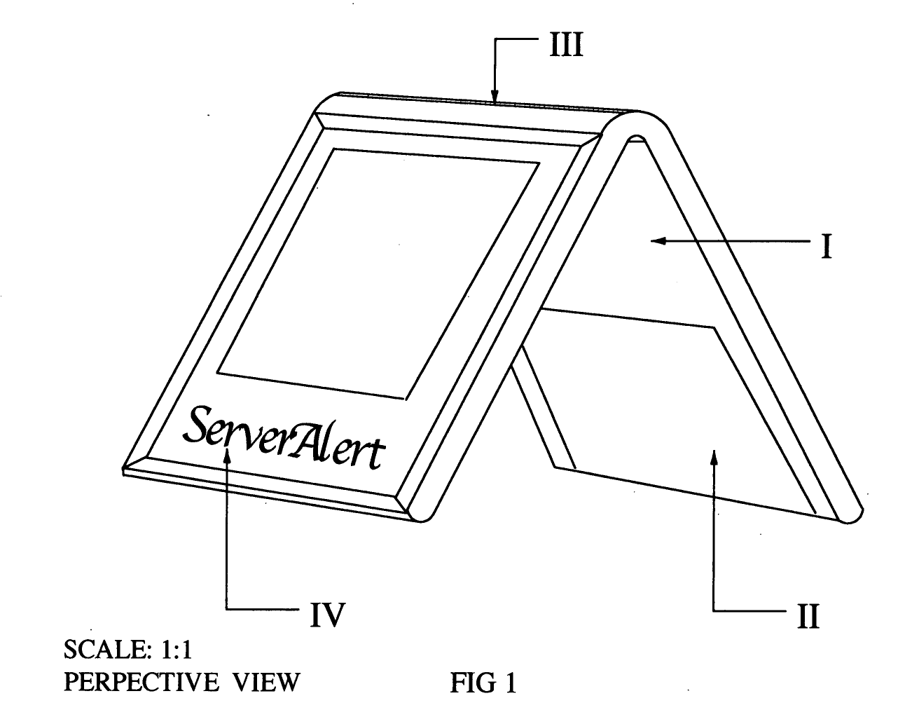

FIG. 1.

I. Transparent plastic base tinted to color selected at a later date. Base used for housing internal components (ie. battery, lighting circuit, on/off switch, wiring).

II. Battery compartment location. Housing for 3 volt flat type battery. plastic cover slips into base for flush fit.

III. Plastic top hinge for unit expansions and folding capabilities.

IV. Location of invention name inscribed in plastic base

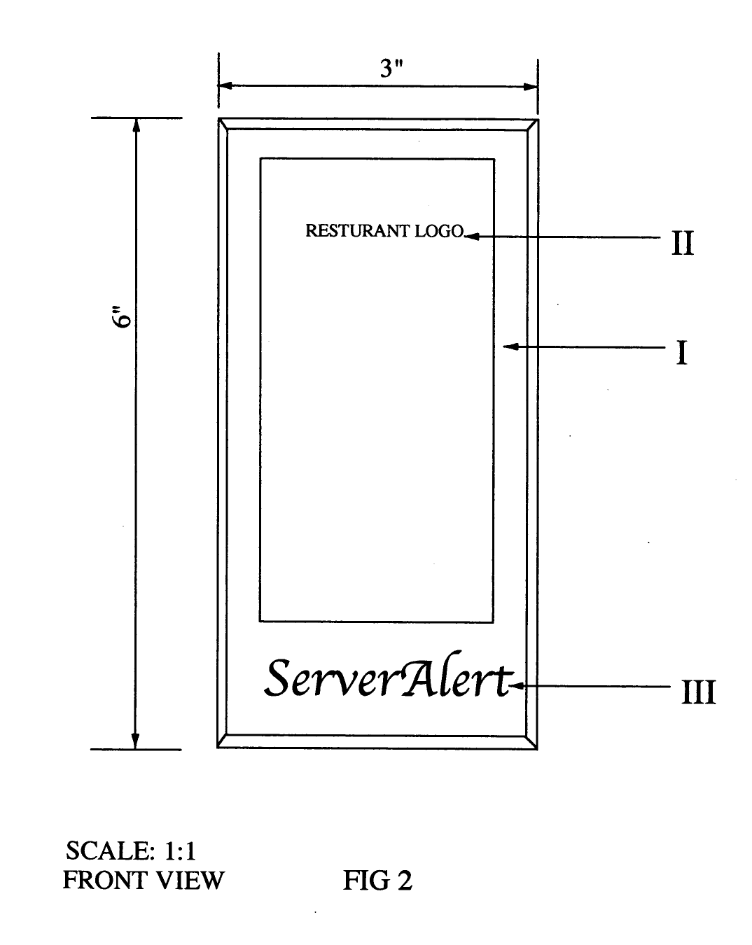

FIG 2.

I. Transparent plastic base backlit with flashing bulbs when illuminated.

II. Location of client logo/business name

III. Location of invention name inscribed in plastic shell.

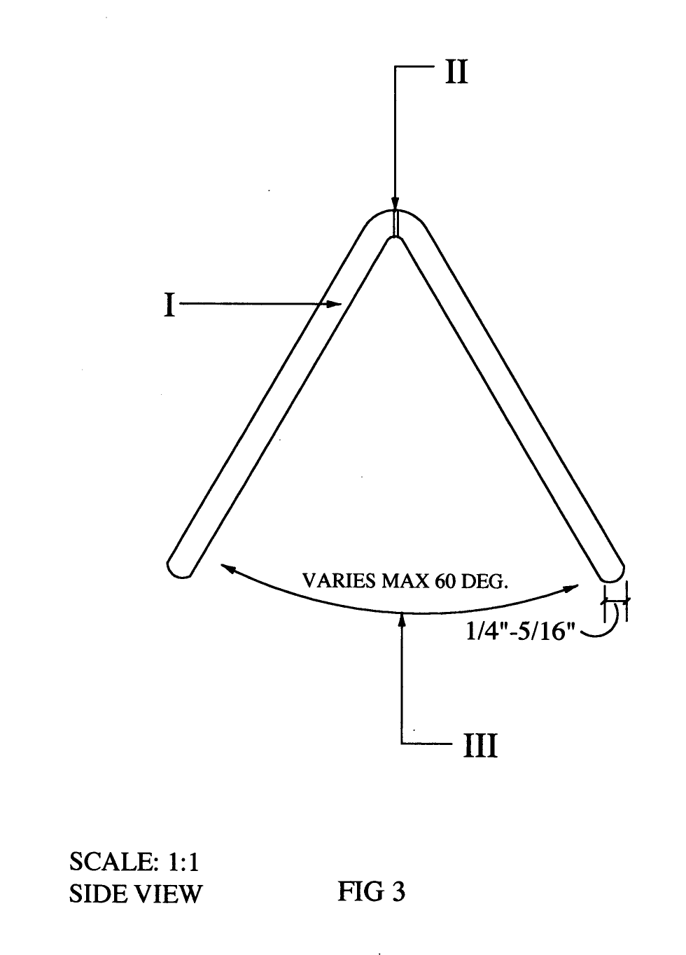

FIG. 3.

I. Transparent plastic shell approx. ¼″-5/16″ in width

II. Plastic top hinge for unit expansions and folding capabilities.

III. Reflects the various degrees of movenment for expanding and folding the unit

1. A devise used for alerting the attention of a resturant server to a table of customers in need of assistance.
The claim comprises of:
A hard color tinted transparent plastic base.
A plastic hinge at the top of base unit for folding and expanding capabilities.
Internal series of flashing bulbs on single curcuit powered by a 3 volt flat battery housed within the said plastic base.
Battery compartment on inside of base panel for flat 3 volt battery.
Plastic battery cover flush with base.
Illumination on/off switch connected to battery activated when unit is expanded beyond 35 degrees and deactivated when unit is folded to 35 degrees or less.
Collapsable base for storing and stacking capabilities.
